(19) United States
(12) Patent Application Publication
(10) Pub. No.: US 2018/0105457 A1
(43) Pub. Date: Apr. 19, 2018

(54) FUNCTIONAL GLASS ARTICLE AND METHOD FOR PRODUCING SAME

(71) Applicant: ASAHI GLASS COMPANY, LIMITED, Chiyoda-ku (JP)

(72) Inventors: Wakako ITO, Chiyoda-ku (JP); Hideyuki HIRAKOSO, Chiyoda-ku (JP)

(73) Assignee: ASAHI GLASS COMPANY, LIMITED, Chiyoda-ku (JP)

(21) Appl. No.: 15/846,875

(22) Filed: Dec. 19, 2017

Related U.S. Application Data
(63) Continuation of application No. PCT/JP2016/070257, filed on Jul. 8, 2016.

(30) Foreign Application Priority Data
Jul. 8, 2015 (JP) 2015-136899
Feb. 26, 2016 (JP) 2016-035614

(51) Int. Cl. C03C 17/25; C03C 15/00; C03B 25/02

(52) U.S. Cl. CPC C03C 17/25; C03C 15/00; C03B 25/025; C03C 2217/78; C03C 2217/214; C03C 2217/22; C03C 2218/116

(57) ABSTRACT

There is provided a functional glass article having high abrasion resistance. The functional glass article comprising: a glass substrate having a first face and a second face on a back face of the first face; and a plurality of particles arranged on the first face and made of a material having a Mohs hardness of 7 or higher, each of the plurality of particles having a particle diameter of 1 nm or more and 300 nm or less, and the plurality of particles including a particle located partly inside the glass substrate, the first face with the plurality of particles having a higher Martens hardness by 150 N/mm² or more than a Martens hardness of the second face.

### CROSS-REFERENCE TO RELATED APPLICATIONS

This application is a continuation of prior International Application No. PCT/JP2016/070257 filed on Jul. 8, 2016 which is based upon and claims the benefit of priority from Japanese Patent Applications No. 2015-136899 filed on Jul. 8, 2015 and No. 2016-035614 filed on Feb. 26, 2016; the entire contents of all of which are incorporated herein by reference.

### TECHNICAL FIELD

The present invention relates to a glass article having a functional surface, in particular, to a glass article excellent in abrasion resistance.

### BACKGROUND

A glass article such as a glass plate is widely used for portable terminals and various displays, window glass and interior material, solar panel and mirror, window glass for vehicle and the like.

There is a known method for imparting excellent functions to the glass article by forming various functional films on the surface of the glass article by a method of wet coating or dry coating. For example, since a standard glass plate deteriorates in strength when abraded, it is proposed to impart abrasion resistance by providing a protective layer on the surface of the glass plate.

For example, JP-A 2003-321251 (KOKAI) discloses an abrasion-resistant glass plate having a surface formed with a film made by dispersing hydrophilic alumina particles in a silica matrix.

### SUMMARY

The glass plate described in JP-A 2003-321251 (KOKAI) has a problem of losing abrasion resistance when the film on the surface of the glass plate is peeled off or becomes worn.

The present invention provides a glass article having a functional surface less losing functionality even if the surface becomes worn. In particular, a functional glass article excellent in abrasion resistance is provided.

The present invention is the following [1] to [17].

[1] A functional glass article comprising: a glass substrate; and a plurality of particles arranged on a surface of the glass substrate, the plurality of particles having a melting point higher than a softening point of the glass substrate, each of the plurality of particles having a particle diameter of 1 nm or more and 300 nm or less, and the plurality of particles including a particle located partly inside the glass substrate.

[2] The functional glass article of [1], wherein the plurality of particles are made of a material having a Vickers hardness of 9 GPa or higher.

[3] The functional glass article of [2], wherein a Martens hardness of the surface of the functional glass article comprising the plurality of particles is higher, by 150 N/mm² or more, than a Martens hardness of the glass substrate.

[4] A functional glass article comprising: a glass substrate having a first face and a second face on a back face of the first face; and a plurality of particles arranged on the first face and made of a material having a Mohs hardness of 7 or higher, each of the plurality of particles having a particle diameter of 1 nm or more and 300 nm or less, and the plurality of particles including a particle located partly inside the glass substrate, the first face with the plurality of particles having a higher Martens hardness by 150 N/mm² or more than a Martens hardness of the second face.

[5] The functional glass article of [1], wherein portions of at least some of the plurality of particles are exposed to an outside of the glass substrate.

[6] The functional glass article of [4], wherein portions of at least some of the plurality of particles are exposed to an outside of the glass substrate.

[7] The functional glass article of [1], wherein all of the plurality of particles are located partly inside the glass substrate.

[8] The functional glass article of [4], wherein all of the plurality of particles are located partly inside the glass substrate.

[9] The functional glass article of [5], wherein the plurality of particles have a value of an average glass contact ratio of a length L_{G} to a length L from 40% or more where the length L_{G} is an outer periphery in a cross-section along a thickness direction in contact with the glass substrate of one particle in the plurality of particles and the length L is an entire outer periphery in a cross-section along a thickness direction of the one particle, the average glass contact ratio being obtained by a cross-section observation method, the method comprising: obtaining a cross section near the first face of the functional glass article by cutting out and finely polishing performed by an ion milling method using a focused ion beam (FIB) or a method obtained a smooth surface equivalent to a smooth surface obtained by the ion milling method; observing the cross section by using an electron microscope at a magnification of 100,000; measuring the length L_{G} and the length L for 10 sample particles partly positioned inside the glass substrate among the plurality of particles; and obtaining the average glass contact ratio by using the length L_{G} and the length L of each of the 10 sample particles.

[10] The functional glass article of [6], wherein the plurality of particles have a value of an average glass contact ratio of a length L_{G} to a length L from 40% or more where the length L_{G} is an outer periphery in a cross-section along a thickness direction in contact with the glass substrate of one particle in the plurality of particles and the length L is an entire outer periphery in a cross-section along a thickness direction of the one particle, the average glass contact ratio being obtained by a cross-section observation method, the method comprising: obtaining a cross section near the first face of the functional glass article by cutting out and finely polishing performed by an ion milling method using a focused ion beam (FIB) or a method obtained a smooth surface equivalent to a smooth surface obtained by the ion milling method; observing the cross section by using an electron microscope at a magnification of 100,000; measuring the length L_{G} and the length L for 10 sample particles partly positioned inside the glass substrate among the plurality of particles; and obtaining the average glass contact ratio by using the length L_{G} and the length L of each of the 10 sample particles.

[11] The functional glass article of [1], wherein the plurality of particles are α alumina particles.

[12] The functional glass article of [4], wherein the plurality of particles are α alumina particles.

[13] The functional glass article of any one of [4], wherein the Martens hardness of the first face is higher than 3000 N/mm².

[14] A method for producing a functional glass article, comprising; preparing a coating solution comprising a plurality of particles having a melting point higher than a softening point of the glass substrate, each of the plurality of particles having an average particle diameter of 1 nm or more and 300 nm or less; preparing a glass substrate; coating a surface of the glass substrate with the coating solution; and performing a heat treatment on the glass substrate coated with the coating solution.

[15] The method for producing a functional glass article of [14], wherein the plurality of particles are made of a material having a Mohs hardness of 7 or higher.

[16] The method for producing a functional glass article of [14], wherein hydrogen fluoride is brought into contact with the surface of the glass substrate to treat the surface, and then the treated surface is coated with the coating solution.

[17] The method for producing a functional glass article of [14], wherein the heat treatment keeps the glass substrate coated with the coating solution at a temperature higher than an annealing point of the glass substrate.

Since functional fine particles are buried in a surface of a glass article, the functional glass article of the present invention is less likely to deteriorate in functionality even if the surface becomes worn. According to the present invention, for example, an abrasion-resistant glass article having high abrasion resistance can be obtained.

### BRIEF DESCRIPTION OF THE DRAWINGS

FIG. 1 is a cross-sectional SEM image near the surface of a functional glass article produced in Example 1.

FIG. 2 is a cross-sectional SEM image near the surface of a functional glass article produced in Example 2.

FIG. 3 is a cross-sectional SEM image near the surface of a functional glass article produced in Example 3.

FIG. 4 is a cross-sectional SEM image near the surface of a functional glass article produced in Example 14.

### DETAILED DESCRIPTION

In this specification, the “particle diameter” means the longer diameter of a particle observed under an electron microscope. The observation magnification is set to, for example, 100,000 times. Besides, the “agglomerated particle diameter” means the average particle diameter by dynamic light scattering particle size distribution measurement. In this specification, the softening point of glass means the softening point specified in ISO 7884-6:1987. Besides, the slow cooling point of glass means the annealing point specified in ISO 7884-7:1987.

Hereinafter, the Martens hardness is the Martens hardness measured by using a microhardness tester (for example, manufactured by Fischer Instruments K.K., PICODENTOR HM500) conforming to ISO 14577 with an indentation load set to 0.05 mN and a holding time set to 10 sec.

[Functional Glass Article]

A functional glass article of the present invention (hereinafter, referred to as “the present glass article”) has a plurality of particles on its surface, and portions of at least some of the plurality of particles are located inside a glass substrate. Accordingly, even if the surface becomes worn, the present glass article keeps its functionality because the portions of the particles exist inside the glass substrate.

The present glass article is, concretely, “the present glass article 1” or “the present glass article 2” described below.

[The Present Glass Article 1]

The present glass article 1 is a functional glass article including a glass substrate and a plurality of functional particles arranged on the surface of the glass substrate. The present glass article 1 has the functional particles arranged on its surface and thereby exhibits a desired function.

In the case where the function of the particles is effectively exhibited due to exposure of the particles from the glass substrate, the present glass article 1 preferably has portions of at least some of the plurality of particles exposed to the outside of the glass substrate. More specifically, an average glass contact ratio L_{G}/L of the particle obtained by the following cross-section observation method is preferably 40% or more and more preferably 50% or more so as to make the particle unlikely to peel off and to obtain high abrasion resistance, where the length L_{G} is an outer periphery in a cross-section along a thickness direction in contact with the glass substrate of one particle in the plurality of particles and the length L is an entire outer periphery in a cross-section along a thickness direction of the one particle.

(Cross-Section Observation Method)

A cross section near the surface of the present glass article is cut out and finely polished, and observed using the electron microscope at a magnification of 100,000. About a particle having a portion of the outer periphery of the particle in contact with the glass substrate and a portion not in contact with the glass substrate, a length L_{G} of the outer periphery in contact with the glass substrate and a length L of the entire outer periphery are measured. About 10 particles, the glass contact ratio L_{G}/L being the average value of the ratio between the length L_{G} of the outer periphery in contact with the glass substrate and the length L of the entire outer periphery is obtained. The fine polishing is performed by an ion milling method using a focused ion beam (FIB) or a method with which a smooth surface equivalent to that by the ion milling method is obtained.

In the present glass article 1, in the case where the smoothness of the surface is required, the whole particle is preferably located inside the glass substrate. When the all of the plurality of particles are located inside the glass substrate, portions of at least some of the plurality of particles are in contact with the surface of the glass substrate. In other words, portions of at least some of the plurality of particles form a portion of the surface of the glass substrate.

In the present glass article 1, the particles are preferably uniformly distributed at an appropriate density according to the purpose. Further, it is preferable that 10 or more particles exist in a field of view observed at a magnification of 100,000 by the above-described observation method because of increased abrasion resistance.

The present glass article 1 preferably has a Martens hardness of the surface containing the plurality of particles higher, by 150 N/mm² or more, than the Martens hardness of the glass substrate because of increased abrasion resistance. The Martens hardness of the glass substrate is typically 2900 N/mm².

<Particle>

In the present glass article 1, the melting point of the particle is higher than the softening point of the glass substrate. Since the melting point of the particle is higher than the softening point of the glass substrate, the particle does not melt when heated to a temperature of equal to or lower than the softening point of the glass substrate.

The softening point of the glass substrate is about 1600° C. when the glass substrate is made of quartz glass, and is about 735° C. when the glass substrate is made of soda lime glass. Examples of the particle having a melting point higher than 1600° C. include particles of diamond, silicon carbide, α alumina, zirconium oxide and the like. Examples of the particle having a melting point of higher than 735° C. include a silver particle and the like in addition to the above-described particles.

The particle diameter of the particle is 1 nm or more and 300 nm or less. Examples of the particle include ultraviolet absorbing particles (titania, zirconia and the like), infrared absorbing particles (ITO, ATO and the like), antibacterial particles (titania, silver-containing mesoporous silica and the like), abrasion resistant particles (α alumina, diamond and the like), photocatalytic particles (titania and the like), heat radiation particles (diamond and the like) and the like.

The particles may be of one kind or two or more kinds.

The shape of the particle is not particularly limited, and its examples include a spherical shape, an egg shape, a spindle shape, an infinite shape, a chain shape, a needle shape, a columnar shape, a bar shape, a flat shape, a scale shape, a leaf shape, a tube shape, a sheet shape and the like. From the viewpoint of easily obtaining excellent abrasion resistance, the particle is preferably in a spherical shape, an egg shape, a spindle shape, or a flat shape.

The particle diameter of the particle is preferably 1 nm or more, more preferably 5 nm or more, and furthermore preferably 10 nm or more. The particle diameter of the particle is 300 nm or less so as to keep the surface property of the present glass article 1, and is preferably 200 nm or less and more preferably 150 nm or less so as to increase the transparency.

The particle is preferably a particle harder than the glass substrate. The hard particle is less likely to wear and therefore less decreases in function due to abrasion.

The Vickers hardness of the particle is preferably higher than the Vickers hardness of the glass substrate. The Vickers hardness of standard soda lime glass used for window glass or the like is about 4.9 GPa or higher and 5.4 GPa or lower, the Vickers hardness of aluminosilicate glass used for a display substrate or the like is about 5.2 GPa or higher and 6.1 GPa or lower, and the Vickers hardness of quartz glass is about 8.6 GPa or higher and 9.8 GPa or lower.

The Vickers hardness of the particle is preferably 7 GPa or higher, and more preferably 9 GPa or higher. Examples of the particle include titania (Vickers hardness:

about 7.8 GPa), zirconia (Vickers hardness: about 10.7 GPa or higher and 12.7 GPa or lower), alumina (Vickers hardness: about 13.7 GPa or higher and 22.5 GPa or lower), diamond (Vickers hardness: about 68.6 GPa or higher and 147 GPa or lower).

<Glass Substrate>

The glass substrate in the present invention is not particularly limited as long as the glass substrate has practical durability, heat resistance and the like. The glass substrate having a specific gravity of 3 or less is preferable because of a possibility of increasing the abrasion resistance with ease by the later-described producing method. Besides, the glass substrate is preferably quartz glass or silicate glass in terms of handiness. Examples of silicate glass include soda lime glass, aluminosilicate glass, borosilicate glass and the like.

The shape of the glass substrate is not particularly limited but may be decided according to the use. The shape of the glass substrate is preferably a plate shape and may be curved. Besides, the size of the glass substrate is not particularly limited and may be appropriately selected according to the use. In the case where the glass substrate is in the plate shape, the thickness of the glass plate is not particularly limited. The thickness of the glass plate is preferably 0.1 mm or more, and more preferably 0.3 mm or more in terms of handiness. Further, the thickness of the glass plate is preferably 10 mm or less and more preferably 5 mm or less in terms of avoiding being too heavy.

The glass substrate may be subjected to a surface treatment. As the surface treatment, a discharge treatment such as plasma treatment, corona treatment, UV treatment, ozone treatment or the like, a chemical treatment with water, acid, alkali or the like, or a physical treatment using an abrasive may be performed.

The glass substrate containing fluorine on its surface is preferable because the functional particles are likely to adhere thereto when heated.

[The Present Glass Article 2]

The present glass article 2 is a functional glass article including a glass substrate having a first face and a second face on a back face of the first face, and a plurality of particles arranged on the first face. Hereinafter, the present glass article 2 will be described, and description common to that of the above-described present glass article 1 will be omitted.

In the present glass article 2, the Martens hardness of the first face containing the plurality of particles is higher, by 150 N/mm² or more, than the Martens hardness of the second face. Therefore, the present glass article 2 is excellent in abrasion resistance at the first face.

In the present glass article 2, the second face may contain particles. In the case where the second face does not contain particles, the Martens hardness of the second face is equal to the Martens hardness of the glass substrate. The Martens hardness of the glass substrate is, for example, 2900 N/mm².

The Martens hardness of the first face is preferably higher, by 300 N/mm² or more, than the Martens hardness of the second face, and is more preferably higher by 500 N/mm² or more. Besides, the Martens hardness of the first face is preferably higher than 3000 N/mm² so as to increase the abrasion resistance, more preferably 3200 N/mm² or higher, and furthermore preferably 3400 N/mm² or higher. The Martens hardness of the first face is typically 15000 N/mm² or lower.

On the first face, portions of some of the plurality of particles preferably exist in the glass substrate within 200 nm from the surface so as to increase the abrasion resistance. The present glass article 2 is high in abrasion resistance at the first face because of the particles contained near the surface of the first face.

All of the plurality of particles may be located inside the glass substrate. The present glass article 2 has at least portions of the particles existing inside the glass substrate, which are less likely to fall from the glass article, and is thus high in wear-resistance. The particles may exist in a portion in the glass substrate separate from 200 nm or more from the surface.

Further, portions of at least some of the plurality of particles are preferably exposed to the outside of the glass substrate. Exposure of the particles makes the glass substrate less worn.

The abrasion resistance of the functional glass article can be evaluated using, for example, a traverse-type wear tester. More specifically, the evaluation can be made by a method of fixing abrasive paper or the like to the traverse-type wear tester and applying a load thereto, reciprocating it on the surface of the functional glass article a predetermined number of times, and then observing the abrasion on the surface of the functional glass article occurring due to the polishing.

<Particle>

The particle is preferably made of a material having a Mohs hardness of 7 or higher. Such a particle can increase the abrasion resistance of the present glass article 2. The particle is preferably made of a material having a Mohs hardness of 8 or higher.

Examples of the material having a Mohs hardness of 7 or higher include: zirconium oxide, aluminum nitride (each having a Mohs hardness: 7); osmium, topaz, zirconium boride (each having a Mohs hardness: 8); tungsten nitride, silicon nitride, titanium nitride, tungsten carbide, tantalum carbide, zirconium carbide, chromium, α alumina, silicon carbide, aluminum boride, boron carbide (each having a Mohs hardness: 9); and diamond (having a Mohs hardness: 10).

The particle is preferably a particle of zirconia, α alumina, or diamond in terms of transparency. The particle is preferably an a alumina particle in terms of handiness.

The particles may be of one kind or two or more kinds.

The particle diameter of the particle is preferably 1 nm or more, more preferably 5 nm or more, and furthermore preferably 10 nm or more so as to increase the abrasion resistance. The particle diameter of the particle is 300 nm or less so as to keep the surface property of the present glass article 2, and is preferably 200 nm or less and more preferably 150 nm or less so as to increase the transparency.

[Method for Producing the Functional Glass Article]

This producing method is a method for producing a functional glass article obtained by preparing a coating solution containing a plurality of particles and a glass substrate (hereinafter, referred to as a “preparation step”), coating the surface of the glass substrate with the coating solution (hereinafter, referred to as a “coating step”), and performing a heat treatment on the glass substrate coated with the coating solution (hereinafter, referred to as a “thermal treatment step”). Both of the above-described present glass article 1 and present glass article 2 can be produced by this producing method.

<Preparation Step>

In the preparation step, a coating solution containing a plurality of particles and a glass substrate are prepared. The glass substrate is the glass substrate in the present glass article. The glass substrate has been described above, and therefore the description will be omitted.

The coating solution contains a plurality of particles and a solvent. The plurality of particles are made of a material having a Mohs hardness of 7 or higher and an average particle diameter of 1 nm or more and 300 nm or less. Further, the plurality of particles have a melting point higher than the softening point of the glass substrate. The particles contained in the coating solution are the particles in the present glass article. The particle has been described above, and therefore the description will be omitted.

In the coating solution, the particles are preferably dispersed uniformly. When the coating solution is uniform, the present glass article is more likely to increase in transparency. The particles may agglomerate in the coating solution. In the case where the particles agglomerate, the agglomerated particle diameter is preferably 450 nm or less, more preferably 300 nm or less, and furthermore preferably 250 nm or less in terms of transparency.

Examples of the solvent include water (distilled water and the like), alcohol (methanol, ethanol, isopropyl alcohol and the like), ether (ethylene glycol monoethyl ether, ethylene glycol monobutyl ether and the like), ketone (acetone, ethyl methyl ketone, cyclohexanone and the like), hydrocarbon (xylene and the like) and the like. In terms of handleability, the solvent is preferably water or alcohol.

The coating solution may further contain a surfactant. The coating solution contains the surfactant and thereby becomes easy to wet the glass substrate and uniformly apply to the glass substrate. As the surfactant, any of an anionic surfactant, a cationic surfactant, and a nonionic surfactant can be used.

As the surfactant, a nonionic surfactant containing a group represented by —CH₂CH₂O—, —SO₂—, —NR— (R is a hydrogen atom or an organic group), —NH₂—, —SO₃Y, —COOY (Y is a hydrogen atom, a sodium atom, a potassium atom, or an ammonium ion) is preferable.

Examples of the nonionic surfactant include alkylpolyoxyethylene ether, alkylpolyoxyethylene-polypropylene ether, fatty acid polyoxyethylene ester, fatty acid polyoxyethylene sorbitan ester, fatty acid polyoxyethylene sorbitol ester, alkylpolyoxyethylene amine, alkylpolyoxyethylene amide, polyether-modified silicone-based surfactant and the like.

The coating solution may contain various paint compounding agents. Examples of the paint compounding agent include a coloring agent, and publicly-known compounding agents imparting functions such as electrical conductivity, antistatic property, polarization property, ultraviolet blocking property, infrared blocking property, antifouling property, antifogging property, photocatalyst function, antibacterial function, phosphorescence, battery function, refractive index control property, water repellency, oil repellency, fingerprint removability, slipperiness and the like. The coating solution may contain an antifoaming chemical, a leveling agent, an ultraviolet absorbent, a viscosity modifier, an antioxidant, a fungicide and the like.

<Coating Step>

The coating step is a step of coating the surface of the glass substrate with the coating solution. The coating may be performed on the whole or a part of the surface of the glass substrate. In the case where the glass substrate is in a plate shape, the coating is preferably performed on a part or the whole of one principal surface, and may be performed on both principal surfaces.

As the coating method, publicly-known methods can be appropriately employed. Examples of the methods include a method using a roller, a method using a brush, spin coating, spray coating, dip coating, die coating, curtain coating, screen coating, flow coating, gravure coating, bar coating, reverse coating, roll coating, and an ink-jet method.

In the case where both surfaces of the glass substrate are desired to be coated with the coating solution, the dip coating is preferable because both the surfaces can be treated at the same time. A single surface may be coated with the coating solution and then subjected to the later-described heat treatment, and then the other surface may be coated with the coating solution.

In the coating step, before the surface of the glass substrate is coated with the coating solution, for example, a fine asperity structure may be formed on the glass surface using the following surface treatment method. It is considered that when the fine asperity structure exists on the surface of the glass substrate, the particles become more likely to enter the glass substrate.

Examples of the surface treatment method for the glass substrate include chemical treatment methods such as exposure of the glass substrate to a hydrogen fluoride solution or a hydrogen fluoride gas, immersion of the glass substrate in a sodium carbonate solution or a sodium hydrogen carbonate solution, and physical treatment methods such as a blast treatment with particles, a laser treatment and the like.

The method using hydrogen fluoride is preferable because a surface layer containing fluorine is formed on the surface of the glass substrate. Since the surface layer containing fluorine is lower in softening temperature than the glass substrate, the viscosity of the surface layer becomes lower than that inside the glass substrate when subjected to the heat treatment. Accordingly, the particles are made easy to adhere to the glass substrate by the heat treatment.

In the coating step, the glass substrate may be dried after coated with the coating solution. In this case, the drying method is not particularly limited. A drying temperature is, for example, 100° C. or higher and 250° C. or lower, and preferably 120° C. or higher and 200° C. or lower. A drying time is, for example, 1 minute or more and 60 minutes or less.

<Thermal Treatment Step>

In the thermal treatment step, the glass substrate coated with the coating solution is subjected to a heat treatment. Conditions of the heat treatment are set according to the composition of the glass substrate. A heat treatment temperature is preferably the annealing point or higher and lower than the softening point of the glass substrate. In other words, the surface of the glass substrate coated with the coating solution is preferably kept at a temperature higher than the annealing point of the glass substrate. This is because the particles adhering to the surface easily enter the inside of the glass substrate. Further, the heat treatment temperature and the holding time are preferably set to the levels at which the glass substrate is not largely deformed, and therefore the treatment is preferably performed at a temperature lower than the softening point.

The heat treatment is preferably performed with the surface coated with the coating solution directed upward in the case where the particles are desired to project from the surface of the glass substrate. Besides, the heat treatment is preferably performed with the surface coated with the coating solution directed downward in the case where a particle layer is desired to be made thick. This is because when the heat treatment is performed with the surface coated with the coating solution directed downward, the particles easily enter the inside of the glass substrate.

A heating unit is not particularly limited but, for example, a muffle furnace, a belt furnace, a light-condensing heating-type electric furnace, a near-infrared lamp heater, an excimer laser, or a carbon dioxide laser can be used.

### EXAMPLES

Hereinafter, the present invention is described in details using examples, but the present invention is not limited to the followings. Examples 1, 2, 5, 7 to 9 and 11 to 15 are examples, Examples 3 and 6 are comparative examples, and Examples 4 and 10 are reference examples.

### Example 1

<Preparation of a Coating Solution>

In a glass container with a capacity of 100 mL, 14 g of water, 10 g of α alumina particles (average particle diameter: 130 nm), and 50 g of zirconia beads (particle diameter of 0.5 mm) were input and dispersed for 24 hours by a bead mill to obtain an α alumina particle dispersion liquid (solid content concentration: 40 mass %). The agglomerated particle diameter of the α alumina particles was 160 nm. Note that the agglomerated particle diameter was measured using a dynamic light scattering particle size distribution measuring device (manufactured by NIKKISO CO., LTD., Microtrac Ultrafine Particle Analyzer UPA-150).

10.0 g of the obtained α alumina particle dispersion liquid, 0.6 g of ethylene glycol monoethyl ether, 1.2 g of ethylene glycol monobuthyl ether, 0.4 g of N-methyl-2-pyrrolidone, 7.8 g of water were mixed together at room temperature to obtain a coating solution 1. The content ratio of the α alumina particles to 100 vol % of solid contents contained in the coating solution 1 was 20 vol %.

### <Preparation of a Functional Glass Plate>

The surface of a quartz glass plate having a thickness of 1.0 mm (manufactured by Asahi Glass Co., Ltd., AQ: annealing point of 1120° C., softening point of 1600° C., Vickers hardness of 8.6 GPa) was polished using cerium oxide fine particles, then the surface was washed with water and dried. Next, the surface of the dried glass plate was spin-coated with the coating solution 1. After the glass plate was dried for 30 minutes at 150° C., the glass plate was put in an electric furnace with the face coated with the coating solution facing up, and subjected to a heat treatment. More specifically, the electric furnace was increased in temperature up to a holding temperature (1200° C.) at a temperature increasing rate of 300° C./h, held for 360 minutes, and decreased in temperature down to room temperature at 300° C./h, thereby performing the heat treatment to obtain a functional glass plate 1.

<Average Particle Diameter and Glass Contact Ratio of a Particle>

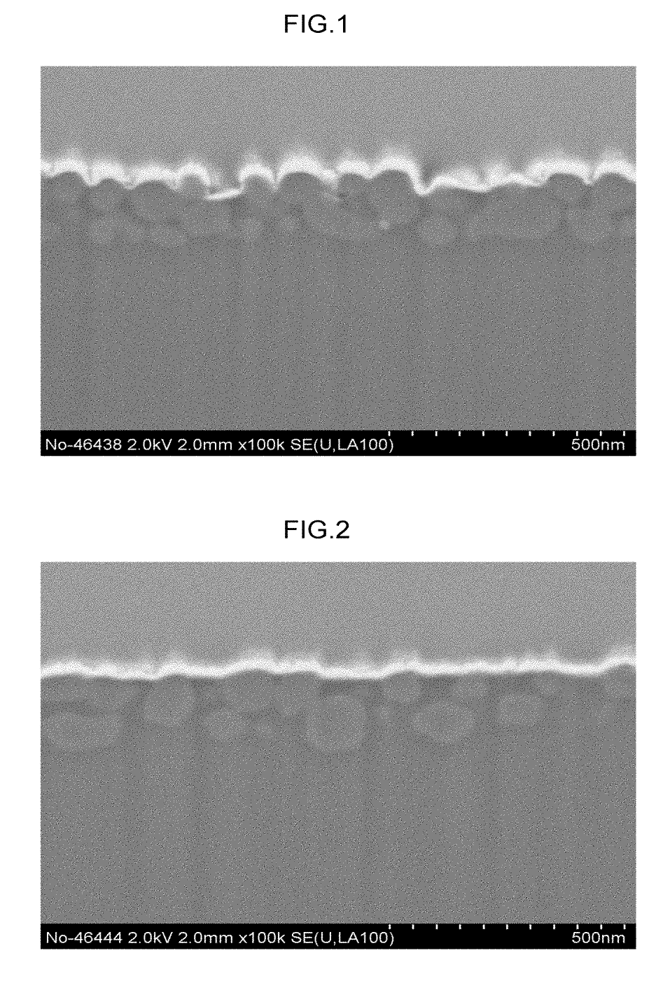

A cross section of the functional glass plate 1 was cut out, and a cross section near the surface was observed by the above-described method. For the observation, a scanning electron microscope (manufactured by Hitachi High-Technologies Corporation, S-4300) was used. A cross-sectional SEM image is indicated in FIG. 1. The average particle diameter (unit: nm) obtained by measuring the particle diameters of 10 particles near the surface is listed in Table 1. The glass contact ratio L_{G}/L (unit: %) of the particle obtained by the above-described method is also listed in Table 1.

<Martens Hardness>

The Martens hardness (unit: N/mm²) of the face (first face) on the side coated with the coating solution measured using an indentation tester (manufactured by Fischer Instruments K.K., PICODENTOR HM500) with a indentation load set to 0.05 mN and a holding time set to 10 seconds is listed in Table 1. A value (unit: N/mm²) obtained by measuring the Martens hardness of a rear surface (second face) not coated with the coating solution and subtracting the Martens hardness of the second face from the Martens hardness of the first face is is listed at a “difference from rear surface” column in Table 1. Note that the Martens hardness of the rear surface was 2900 N/mm².

<Haze>

The haze (unit: %) was measured using a haze meter (manufactured by MURAKAMI COLOR RESEARCH LABORATORY, HM-65L2). In the use required to have transparency, the haze is preferably 6% or less and more preferably 1% or less. Note that the haze of the quartz glass plate was 0.1%.

<Abrasion Resistance>

The face on the side coated with the coating solution was abraded under the following conditions using the traverse-type wear tester, and the abrasion was visually observed. The face without no abrasion was determined as “excellent”, the face with not more than three abrasions was determined as “good”, and the face with three or more abrasions was determined as “bad.”

(Test Conditions)

Abrasive cloth: G#320 (article in conformity to JIS R6251 standard),

Load: 100 g,

Stroke width: 4 cm,

Number of strokes: 50 rounds, and

Wear area: 1 cm².

### Examples 2 to 4

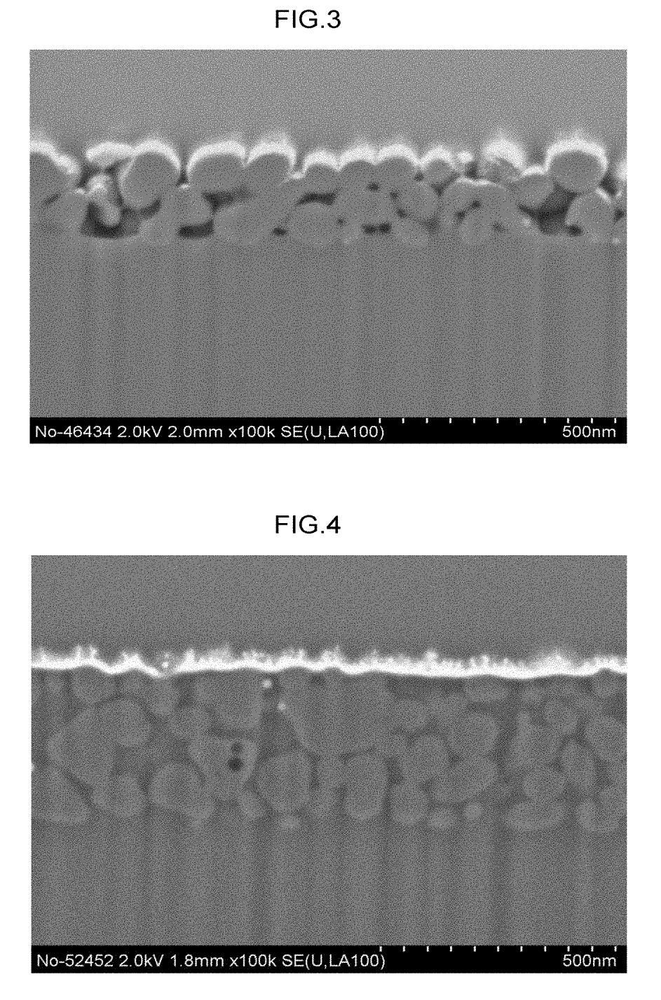

Functional glass plates 2 to 4 were obtained similarly to Example 1 except that the holding temperature was set to temperatures listed in Table 1. Evaluation results are listed in Table 1. However, bracketed values in tables are estimated values. Further, cross-sectional SEM images of the functional glass plates 2, 3 are indicated in FIG. 2, FIG. 3, respectively. Note that a negative value of “difference from rear surface” means that the

Martens hardness of the face (first face) on the side coated with the coating solution is lower than the Martens hardness of the rear surface not coated with the coating solution.

### Example 5

A coating solution 2 was obtained similarly to the coating solution 1 except that α alumina particles (average particle diameter: 300 nm) were used in place of the α alumina particles (average particle diameter: 130 nm). A functional glass plate 5 was obtained similarly to Example 1 except that the coating solution 2 was used in place of the coating solution 1. Evaluation results are listed in Table 1.

### Example 6

A coating solution 3 was obtained similarly to Example 1 except that amorphous silica (Mohs hardness of 5 or higher and 6 or lower) particles were used in place of the α alumina particles. A functional glass plate 6 was obtained similarly to Example 1 except that the coating solution 3 was used in place of the coating solution 1. Evaluation results are listed in Table 2.

### Example 7

A functional glass plate 7 was obtained similarly to Example 1 except that a soda lime glass plate having a thickness of 2.0 mm (manufactured by Asahi Glass Co., Ltd., AS: annealing point of 554° C., softening point of 735° C., Vickers hardness of 5.1 GPa) was used, the temperature increasing rate was set to 400° C./h, the holding temperature was set to 750° C., and the holding time was set to 10 minutes. Evaluation results are listed in

Table 2. Note that the Martens hardness of the rear surface was 2900 N/mm². Further, the haze of the soda lime glass plate was 0.1%.

### Examples 8 to 10

Functional glass plates 8 to 10 were obtained similarly to Example 7 except that the holding temperature was set to temperatures listed in Table 2. Evaluation results are listed in Table 2.

### Example 11

0.3 g of ethylene glycol monoethyl ether, 0.7 g of ethylene glycol monobuthyl ether, 0.2 g of N-methyl-2-pyrrolidone, and 6.3 g of water were added to 2.5 g of the α alumina particle dispersion liquid similar to that in Example 1 and mixed together to obtain a coating solution 4. The content ratio of the α alumina particles to 100 vol % of solid contents contained in the coating solution 4 was 10 vol %.

In a state where a soda lime glass plate having a thickness of 2.0 mm (manufactured by Asahi Glass Co., Ltd., AS) was heated to 560° C., gas containing trifluoroacetic acid was sprayed to its surface. The gas containing trifluoroacetic acid was thermally decomposed on the surface of the glass plate to generate hydrogen fluoride. A hydrogen fluoride concentration in the atmosphere near the surface of the glass plate was about 2.4 vol %. The glass plate after the gas was sprayed was washed with water and dried, and then the surface roughness of the glass plate was measured using a scanning probe microscope (manufactured by SII NanoTechnology Inc., SPA400). An arithmetic average surface roughness Ra of the face subjected to the surface treatment was 8 nm.

The surface of the above-described glass plate etched was spin-coated with the coating solution 4. After the glass plate was dried for 30 minutes at 150° C., the glass plate was put in an electric furnace with the face coated with the coating solution facing up, and subjected to a heat treatment. More specifically, the electric furnace was increased in temperature up to a holding temperature (650° C.) at a temperature increasing rate of 300° C./h, held for 600 minutes, and decreased in temperature down to room temperature at 300° C./h, thereby performing the heat treatment to obtain a functional glass plate 11. Evaluation results are listed in Table 3.

### Example 12

The surface of aluminosilicate glass having a thickness of 0.6 mm (manufactured by Asahi Glass Co., Ltd., brand name Dragontrail: annealing point of 606° C., softening point of 830° C., Vickers hardness of 6.5 GPa) was polished using cerium oxide fine particles, then the surface was washed with water and dried, and the surface was spin-coated with the coating solution 4. After the glass plate was dried for 30 minutes at 150° C., the glass plate was put in an electric furnace with the face coated with the coating solution facing up, and subjected to a heat treatment. More specifically, the electric furnace was increased in temperature up to a holding temperature (830° C.) at a temperature increasing rate of 1600° C./h, held for 5 minutes, and decreased in temperature down to room temperature at 1600° C./h, thereby performing the heat treatment to obtain a functional glass plate 12. Evaluation results are listed in Table 3. Note that the Martens hardness of the aluminosilicate glass was 3500 N/mm², and the haze was 0.1%.

### Example 13

A functional glass plate 13 was obtained similarly to Example 1 except that a glass plate was put in an electric furnace with the face coated with the coating solution facing down and subjected to a heat treatment. Evaluation results are listed in Table 3.

### Example 14

A functional glass plate 14 was obtained similarly to Example 13 except that the coating solution 4 was used in place of the coating solution 1 and the holding temperature in the heat treatment was set to 1150° C. Evaluation results are listed in Table 3. Further, a cross-sectional SEM image of the functional glass plate 14 is indicated in FIG. 4.

### Example 15

0.3 g of ethylene glycol monoethyl ether, 0.5 g of ethylene glycol monobuthyl ether, 0.2 g of N-methyl-2-pyrrolidone, and 1.5 g of water were added to 7.5 g of the α alumina particle dispersion liquid similar to that in Example 1 and mixed together to obtain a coating solution 5. The content ratio of the α alumina particles to 100 vol % of solid contents contained in the coating solution 5 was 30 vol %. A functional glass plate 15 was obtained similarly to Example 13 except that the coating solution 5 was used in place of the coating solution 1. Evaluation results are listed in Table 3.

TABLE 1

| Example | | 1 | 2 | 3 | 4 | 5 |
|---|---|---|---|---|---|---|
| Glass substrate | | Quartz | Quartz | Quartz | Quartz | Quartz |
| Particle | Material | α | α | α | α | α |
| | | alumina | alumina | alumina | alumina | alumina |
| | Mohs hardness | 9 | 9 | 9 | 9 | 9 |
| | Vickers hardness | 13.7 | 13.7 | 13.7 | 13.7 | 13.7 |
| | (GPa) | | | | | |
| | Agglomerated | 160 | 160 | 160 | 160 | 300 |
| | particle diameter | | | | | |
| | (nm) | | | | | |
| Thermal | Holding | 1200 | 1300 | 1100 | 1400 | 1200 |
| treatment | temperature (° C.) | | | | | |
| conditions | Holding time (min) | 360 | 360 | 360 | 360 | 360 |
| Surface | Average particle | 86 | 100 | 107 | [130] | [300] |
| | diameter (nm) | | | | | |
| | L_{G}/L (%) | 62 | 74 | 37 | unmeasurable | [55] |
| | SEM image | FIG. 1 | FIG. 2 | FIG. 3 | | |
| Evaluation | Haze (%) | 0.3 | 0.3 | 0.3 | unmeasurable | 20 |
| | Martens hardness | 5000 | 3200 | 2300 | unmeasurable | 5500 |
| | (N/mm²) | | | | | |
| | Difference from rear | 2100 | 300 | −600 | Unknown | 2600 |
| | surface (N/mm²) | | | | | |
| | Abrasion resistance | Excellent | Excellent | Good | unevaluable | Excellent |

TABLE 2

| Example | | 6 | 7 | 8 | 9 | 10 |
|---|---|---|---|---|---|---|
| Glass substrate | | Quartz | Soda lime | Soda lime | Soda lime | Soda lime |
| Particle | Material | Amorphous | α | α | α | α |
| | | silica | alumina | alumina | alumina | alumina |
| | Mohs hardness | 5~6 | 9 | 9 | 9 | 9 |
| | Vickers hardness | | 13.7 | 13.7 | 13.7 | 13.7 |
| | (GPa) | | | | | |
| | Agglomerated | 160 | 160 | 160 | 160 | 150 |
| | particle diameter | | | | | |
| | (nm) | | | | | |
| Thermal | Holding | 1200 | 750 | 800 | 850 | 900 |
| treatment | temperature (° C.) | | | | | |
| conditions | Holding time (min) | 360 | 10 | 10 | 10 | 10 |
| Surface | Average particle | [60] | [110] | [105] | [105] | [150] |
| | diameter (nm) | | | | | |
| | L_{G}/L (%) | [50] | [18] | [40] | [58] | unmeasurable |
| Evaluation | Haze (%) | 0.2 | 0.4 | 0.4 | 0.4 | unmeasurable |
| | Martens hardness | 3000 | 3400 | 4400 | 4100 | unmeasurable |
| | (N/mm²) | | | | | |
| | Difference from | 100 | 500 | 1500 | 1200 | unknown |
| | rear surface (N/mm²) | | | | | |
| | Abrasion resistance | Bad | Good | Excellent | Excellent | unevaluable |

TABLE 3

| Example | | 11 | 12 | 13 | 14 | 15 |
|---|---|---|---|---|---|---|
| Glass substrate | | Soda lime | Alumino- | Quartz | Quartz | Quartz |
| | | | silicate | | | |
| Particle | Material | α | α | α | α | α |
| | | alumina | alumina | alumina | alumina | alumina |
| | Mohs hardness | 9 | 9 | 9 | 9 | 9 |
| | Vickers hardness | 13.7 | 13.7 | 13.7 | 13.7 | 13.7 |
| | (GPa) | | | | | |
| | Agglomerated | 160 | 160 | 160 | 160 | 150 |
| | particle diameter | | | | | |
| | (nm) | | | | | |
| Thermal | Holding | 650 | 830 | 1200 | 1150 | 1200 |
| treatment | temperature (° C.) | | | | | |
| conditions | Holding time (min) | 600 | 5 | 360 | 360 | 360 |
| Surface | Average particle | [150] | [150] | [150] | [150] | [150] |
| | diameter (nm) | | | | | |
| | L_{G}/L (%) | | | | | |
| | SEM image | | | | FIG. 4 | |
| Evaluation | Haze (%) | | | | | |
| | Martens hardness | | 3650 | 4900 | 6800 | 7300 |
| | (N/mm²) | | | | | |
| | Difference from | | 150 | 2000 | 3900 | 4400 |
| | rear surface | | | | | |
| | (N/mm²) | | | | | |
| | Abrasion resistance | Excellent | Excellent | Excellent | Excellent | Excellent |

Example 3 was insufficient in abrasion resistance. It is considered that the thermal treatment temperature was low and therefore the particles were likely to peel off. In Example 4 and Example 10, the glass plates were deformed and evaluation of them was impossible. It is considered that the thermal treatment temperatures were too higher. Example 6 using the silica particles having low Mohs hardness was insufficient in abrasion resistance. In comparison between Example 1 and Example 5, Example 1 having a smaller particle diameter is excellent in transparency.

The functional glass article of the present invention is suitable for protection glass (protection glass, rear glass and the like for a display) for electronic devices such as a smartphone and the like, window glass (rear glass, side window glass, roof glass and the like) for transportation apparatuses such as an automobile and the like, and building glass.

What is claimed is:

1. A functional glass article comprising:
a glass substrate; and
a plurality of particles arranged on a surface of the glass substrate, the plurality of particles having a melting point higher than a softening point of the glass substrate, each of the plurality of particles having a particle diameter of 1 nm or more and 300 nm or less, and the plurality of particles including a particle located partly inside the glass substrate.

2. The functional glass article according to claim 1,
wherein the plurality of particles are made of a material having a Vickers hardness of 9 GPa or higher.

3. The functional glass article according to claim 2,
wherein a Martens hardness of the surface of the functional glass article comprising the plurality of particles is higher, by 150 N/mm² or more, than a Martens hardness of the glass substrate.

4. A functional glass article comprising:
a glass substrate having a first face and a second face on a back face of the first face; and
a plurality of particles arranged on the first face and made of a material having a Mohs hardness of 7 or higher, each of the plurality of particles having a particle diameter of 1 nm or more and 300 nm or less, and the plurality of particles including a particle located partly inside the glass substrate, the first face with the plurality of particles having a higher Martens hardness by 150 N/mm² or more than a Martens hardness of the second face.

5. The functional glass article according to claim 1,
wherein portions of at least some of the plurality of particles are exposed to an outside of the glass substrate.

6. The functional glass article according to claim 4,
wherein portions of at least some of the plurality of particles are exposed to an outside of the glass substrate.

7. The functional glass article according to claim 1,
wherein all of the plurality of particles are located partly inside the glass substrate.

8. The functional glass article according to claim 4,
wherein all of the plurality of particles are located partly inside the glass substrate.

9. The functional glass article according to claim 5,
wherein the plurality of particles have a value of an average glass contact ratio of a length L_{G} to a length L from 40% or more where the length L_{G} is an outer periphery in a cross-section along a thickness direction in contact with the glass substrate of one particle in the plurality of particles and the length L is an entire outer periphery in a cross-section along a thickness direction of the one particle, the average glass contact ratio being obtained by a cross-section observation method, the method comprising:
obtaining a cross section near the first face of the functional glass article by cutting out and finely polishing performed by an ion milling method using a focused ion beam (FIB) or a method obtained a smooth surface equivalent to a smooth surface obtained by the ion milling method;
observing the cross section by using an electron microscope at a magnification of 100,000;
measuring the length L_{G} and the length L for 10 sample particles partly positioned inside the glass substrate among the plurality of particles; and
obtaining the average glass contact ratio by using the length L_{G} and the length L of each of the 10 sample particles.

10. The functional glass article according to claim 6,
wherein the plurality of particles have a value of an average glass contact ratio of a length L_{G} to a length L from 40% or more where the length L_{G} is an outer periphery in a cross-section along a thickness direction in contact with the glass substrate of one particle in the plurality of particles and the length L is an entire outer periphery in a cross-section along a thickness direction of the one particle, the average glass contact ratio being obtained by a cross-section observation method, the method comprising:
obtaining a cross section near the first face of the functional glass article by cutting out and finely polishing performed by an ion milling method using a focused ion beam (FIB) or a method obtained a smooth surface equivalent to a smooth surface obtained by the ion milling method;
observing the cross section by using an electron microscope at a magnification of 100,000;
measuring the length L_{G} and the length L for 10 sample particles partly positioned inside the glass substrate among the plurality of particles; and
obtaining the average glass contact ratio by using the length L_{G} and the length L of each of the 10 sample particles.

11. The functional glass article according to claim 1,
wherein the plurality of particles are α alumina particles.

12. The functional glass article according to claim 4,
wherein the plurality of particles are α alumina particles.

13. The functional glass article according to claim 4,
wherein the Martens hardness of the first face is higher than 3000 N/mm².

14. A method for producing a functional glass article, comprising;
preparing a coating solution comprising a plurality of particles having a melting point higher than a softening point of the glass substrate, each of the plurality of particles having an average particle diameter of 1 nm or more and 300 nm or less;
preparing a glass substrate;
coating a surface of the glass substrate with the coating solution; and
performing a heat treatment on the glass substrate coated with the coating solution.

15. The method for producing a functional glass article according to claim 14,
wherein the plurality of particles are made of a material having a Mohs hardness of 7 or higher.

16. The method for producing a functional glass article according to claim 14,
wherein hydrogen fluoride is brought into contact with the surface of the glass substrate to treat the surface, and then the treated surface is coated with the coating solution.

17. The method for producing a functional glass article according to claim 14,
wherein the heat treatment keeps the glass substrate coated with the coating solution at a temperature higher than an annealing point of the glass substrate.
